(19) United States
(12) Patent Application Publication
(10) Pub. No.: US 2023/0338215 A1
(43) Pub. Date: Oct. 26, 2023

(54) SUPPORT SURFACE OVERLAY SYSTEM WITH WORKING FLUID RECYCLING

(71) Applicant: DABIR SURFACES, INC., Chicago, IL (US)

(72) Inventors: Anatoliy NITSA, Buffalo Grove, IL (US); Terry CHUNG, Kildeer, IL (US); David A. DZIOBA, Freeland, MI (US)

(21) Appl. No.: 18/138,848

(22) Filed: Apr. 25, 2023

Related U.S. Application Data
(60) Provisional application No. 63/335,036, filed on Apr. 26, 2022.

(51) Int. Cl. A61G 7/057

(52) U.S. Cl. CPC A61G 7/05776; A61G 2203/34; A61G 2203/10

(57) ABSTRACT

A support surface overlay system includes a support surface overlay including a bladder having first and second selectively inflatable compartments and an envelope enclosing the bladder. A control system is connectable to the support surface overlay and operable to selectively inflate one of the selectively inflatable compartments while simultaneously evacuating the other of the selectively inflatable compartments and a volume between the bladder and the envelope.

### CROSS REFERENCE TO RELATED APPLICATION

This application claims the benefit of priority under 35 U.S.C. § 119(e) to U.S. Provisional Patent Application No. 63/335,036, filed Apr. 26, 2022. The disclosure set forth in the referenced application is incorporated herein by reference in its entirety.

### BACKGROUND AND SUMMARY OF THE DISCLOSURE

Therapeutic support surface overlays for supporting patients are known in the art. Some such overlays include first and second independently inflatable compartments that may be alternately inflated and deflated so as to alternatingly apply and relieve support pressure to and from the patient's body. By alternatingly applying and relieving support pressure to and from the patient's body, such an overlay much mitigate the formation of, or assist in the treatment of, decubitus ulcers (commonly referred to as pressure ulcers).

Such overlays commonly are provided with control systems including pumps and valves configured to inflate and deflate the first and second inflatable compartments. Such control systems typically vent inflated compartments to atmosphere in order to deflate them, and draw air from the atmosphere in order to inflate deflated compartments. Such control systems can be energy inefficient, and they might not function to fully deflate the inflated compartments, thereby adversely impacting the efficacy of the overlay.

One known therapeutic support surface overlay system, disclosed in co-pending and co-owned U.S. patent application Ser. No. 17/246,372, the disclosure of which is incorporated in its entirety herein by reference, includes a therapeutic support surface overlay having a first inflatable compartment, a second inflatable compartment, and an envelope enclosing the first and second inflatable compartments, wherein the first inflatable compartment defines a first variable air volume, the second inflatable compartment defines a second variable air volume separate from and independent of the first variable air volume, and the envelope defines a third variable air volume separate from and independent of the first variable air volume and the second variable air volume.

The foregoing system also includes a control system for use with the support surface overlay. The control system includes: a pneumatic pump having a pump inlet port and a pump outlet port; a first three-way control valve having a first port fluidly coupled to the pump inlet port, a second port configured to be fluidly coupled to the first variable air volume, and a third port coupled to the pump outlet port; a second three-way control valve having a first port fluidly coupled to the pump inlet port, a second port configured to be fluidly coupled to the second variable air volume, and a third port coupled to the pump outlet port; and an inlet flow control device having a first port fluidly coupled to an environment external to the control system and a second port fluidly coupled to the pump inlet port.

The control system is configured to selectively and alternatingly inflate and deflate the first and second inflatable compartments and to concurrently evacuate fluid from an uninflated one of the first and second inflatable compartments. In some embodiments, the control system includes an envelope suction port configured for fluid connection to the third variable air volume. The envelope suction port is separate from and independent of the first and second variable air volumes. In such embodiments, the control system may be configured to evacuate fluid from the envelope as well as from the uninflated one of the first and second inflatable compartments.

The foregoing system further includes three fluid lines extending from the support surface overlay to the control system and may utilize a three-line connector disposed between the control system and the overlay to provide for quick connection and disconnection of the fluid lines.

A therapeutic support surface overlay system according to the present disclosure similarly includes a therapeutic support surface overlay and a control system for use with the support surface overlay.

The support surface overlay includes a first inflatable compartment, a second inflatable compartment, and an envelope enclosing the first and second inflatable compartments, wherein the first inflatable compartment defines a first variable air (or other working fluid) volume, the second inflatable compartment defines a second variable air (or other working fluid) volume separate from and independent of the first variable air volume, and the envelope defines a third variable air (or other working fluid) volume separate from and independent of the first variable air volume and the second variable air volume.

The control system includes: a pneumatic pump having a pump inlet port and a pump outlet port; a first three-way control valve having a first port fluidly coupled to the pump inlet port, a second port fluidly coupled to the first variable working fluid volume, and a third port coupled to the pump outlet port; and a second three-way control valve having a first port fluidly coupled to the pump inlet port, a second port fluidly coupled to the second variable working fluid volume and to the third variable working fluid volume, and a third port coupled to the pump outlet port. The pump and the first and second three-way control valves may be selectively configured, for example, to concurrently inflate the first compartment and deflate or evacuate the second compartment and the envelope, or to concurrently inflate the second compartment and deflate or evacuate the first compartment.

In embodiments, the second port of the first three-way control valve is further fluidly coupled to the third variable working fluid volume. In such embodiments, the pump and the first and second three-way control valves may be selectively configured, for example, to concurrently inflate the first compartment and deflate or evacuate the second compartment and the envelope, or to concurrently inflate the second compartment and deflate or evacuate the first compartment and the envelope.

The system according to the present disclosure includes two fluid lines extending from the support surface overlay to the control system and may utilize a two-line connector disposed between the control system and the overlay to provide for quick connection and disconnection of the fluid lines.

In other embodiments, the therapeutic support surface overlay system may include any combination of features as described further herein.

These and other features of the present disclosure will become more apparent from the following description of illustrative embodiments.

### BRIEF DESCRIPTION OF THE DRAWINGS

FIG. 1A is a top plan view of an illustrative therapeutic support surface overlay for use in a system according to the present disclosure, the support surface overlay including a bladder disposed within an interior region of an envelope, wherein the bladder includes first and second sheets joined together by a seam to thereby define first and second selectively and independently inflatable compartments, and wherein the envelope includes first and second panels and a seam joining the first and second panels to the bladder, the overlay further including a first bladder tube extending from the first inflatable compartment, a second bladder tube extending from the second inflatable compartment, and an envelope evacuation tube extending from the envelope and fluidly coupled to the second bladder tube outside the envelope;

FIG. 1B is a top plan view of a variant of the illustrative therapeutic support surface overlay for use in a system according to the present disclosure, the support surface overlay of FIG. 1B being identical to the support surface overlay of FIG. 1A except that the envelope evacuation tube does not extend from the envelope and instead is fluidly coupled to the second bladder tube within the envelope;

FIG. 2A is a bottom plan view of the support surface overlay of FIG. 1A;

FIG. 2B is a bottom plan view of the support surface overlay of FIG. 1B;

FIG. 3 is a cross-sectional view of the support surface overlays of FIGS. 1A and 1B;

FIG. 4 is a detail view of a portion of the support surface overlays of FIGS. 1A and 1B;

FIG. 5 is a side elevation view of the support surface overlay system of FIG. 1A;

FIG. 6A is a partial top plan view of the support surface overlay of FIG. 1A, showing some of the features thereof in greater detail;

FIG. 6B is a partial top plan view of the support surface overlay of FIG. 1B, showing some of the features thereof in greater detail;

FIG. 7 is a schematic diagram of an illustrative support surface overlay system according to the present disclosure in a first operational state, the system including the support surface overlay of FIGS. 1-6 and a pneumatic control system, wherein the pneumatic control system is in an “off” or “idle” state;

FIG. 7A is a schematic diagram of an alternative form of inlet flow controller for the pneumatic control system of FIG. 7;

FIG. 7B is a schematic diagram of another alternative form of inlet flow controller for the pneumatic control system of FIG. 7;

FIG. 7C is a schematic diagram of a further alternative form of inlet flow controller for the pneumatic control system of FIG. 7;

FIG. 8 is a schematic diagram of the illustrative support surface overlay system in a second operational state wherein the pneumatic control system is configured to selectively pressurize the first inflatable compartment of the bladder, and to selectively withdraw air from the interior region of the second inflatable compartment of the bladder and from the envelope of the support surface overlay; and

FIG. 9 is a schematic diagram of the illustrative support surface overlay system in a third operational state wherein the pneumatic control system is configured to selectively pressurize the second inflatable compartment of the bladder, and to selectively withdraw air from the interior region of the first inflatable compartment of the bladder.

### DETAILED DESCRIPTION OF THE DRAWINGS

For the purposes of promoting an understanding of the disclosure, one or more illustrative embodiments shown in the drawings and variations thereof will now be described in detail.

As used herein, and as would be recognized by one skilled in the art, the phrase “aligned with” means “fluidly coupled to” or “in fluid communication with” or the like. Similarly, the term “isolated” as used herein means “not aligned with” or “not fluidly coupled to” or “not in fluid communication with.” Also, references to “air” herein should be construed to include other working fluids to the greatest extent possible.

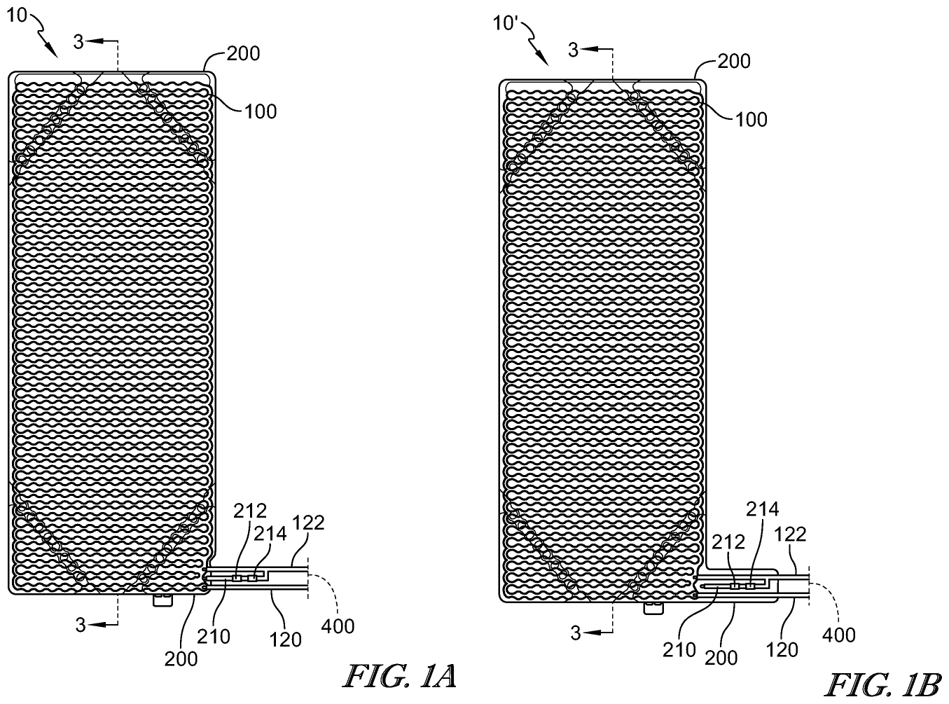

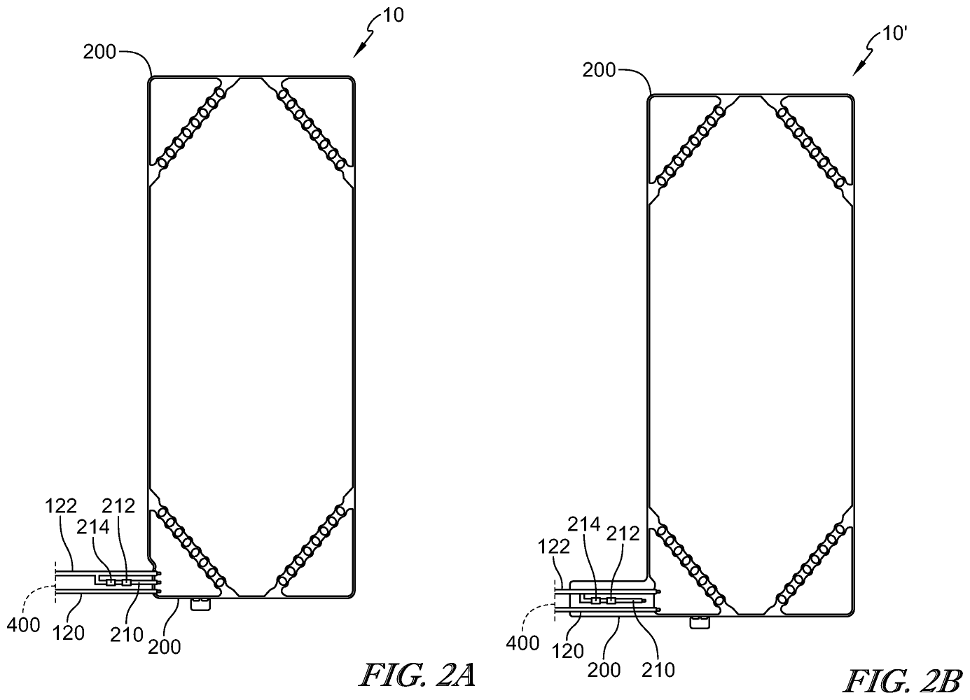

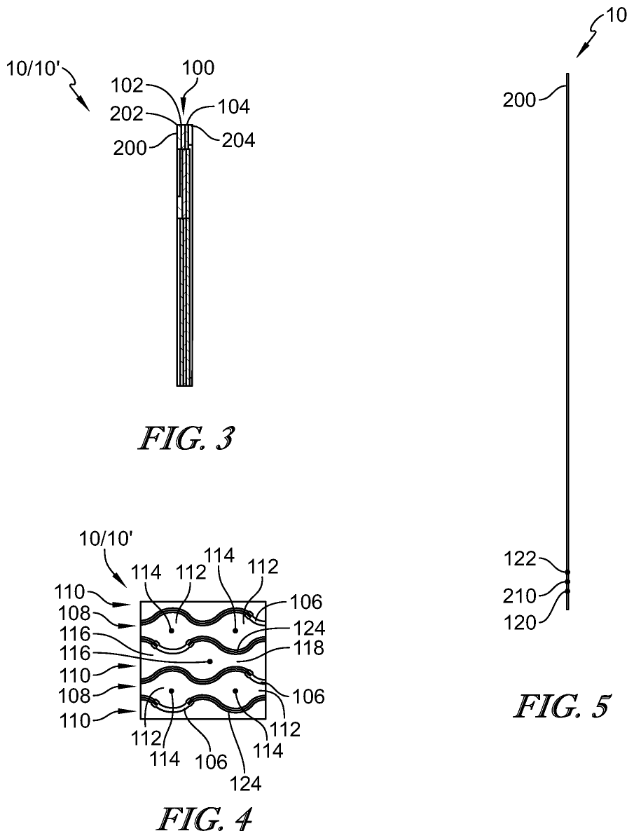

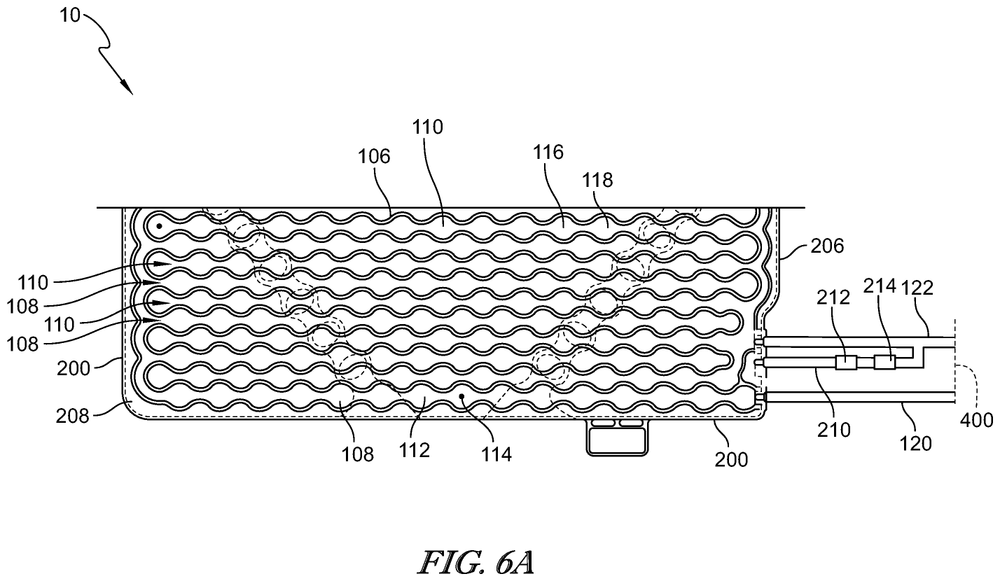

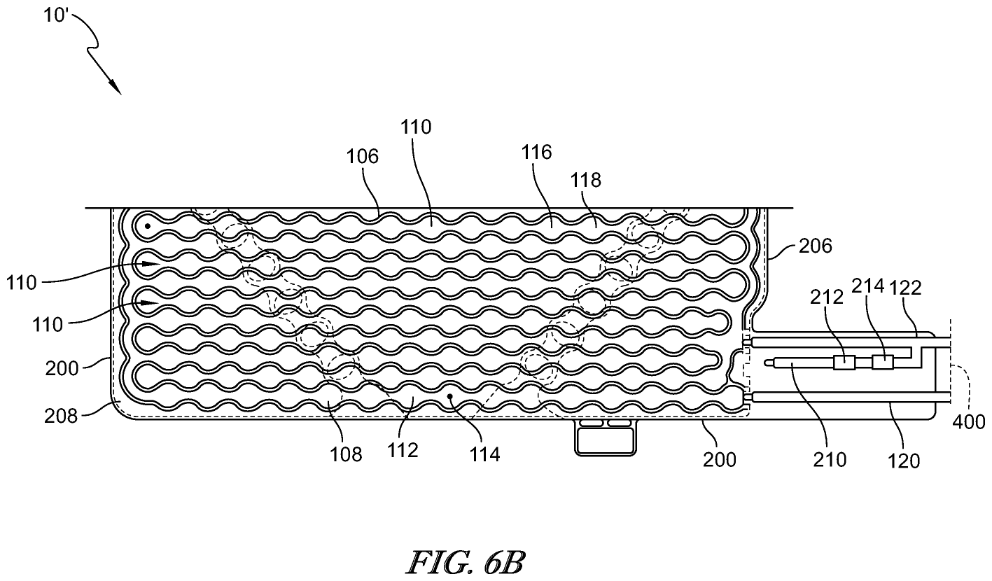

FIGS. 1A, 2A, 3-5, and 6A show an illustrative therapeutic support surface overlay 10 according to the present disclosure. (FIGS. 1B, 2B, 3-5, and 6B show an alternative illustrative therapeutic support surface overlay 10′ according to the present disclosure, as will be discussed further below.) The support surface overlay 10 includes an illustrative support bladder 100 disposed within an illustrative envelope 200. The bladder 100 includes a first (or upper) flat, flexible sheet 102 overlying a second (or lower) flat, flexible sheet 104. One or both of the first and second sheets 102, 104 may be imperforate. The first and second sheets 102, 104 are joined together by a generally sinusoidal seam 106, thereby defining first and second, interdigitated, inflatable compartments 108, 110. The first inflatable compartment 108 defines a first variable air volume Z1, and the second inflatable compartment 110 defines a second variable air volume Z2 separate from and independent of the first variable air volume Z1. As best shown in FIG. 4, the seam 106 may define one or more relief cuts 124, for example, as further described in U.S. Pat. No. 9,216,122, the disclosure of which is incorporated by reference herein.

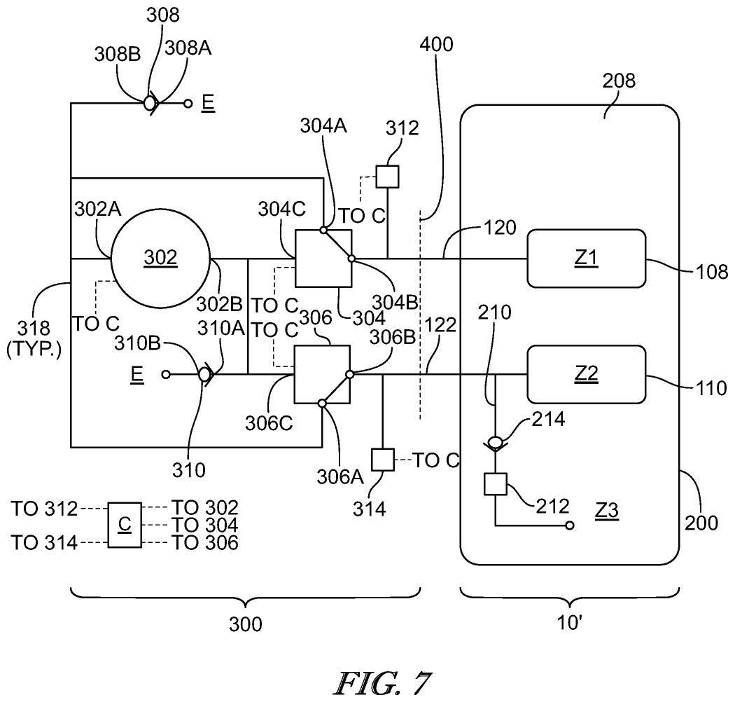

The first and second inflatable compartments 108, 110 may be selectively and independently inflated and deflated. The first compartment 108 may define a first plurality of inflatable cells 112 arranged in rows, each of the first plurality of inflatable cells 112 defining a corresponding contact node 114 when inflated. The second inflatable compartment 110 may define a second plurality of inflatable cells 116 arranged in rows interdigitated with the rows of the first plurality of inflatable cells 112, each of the second of inflatable cells 116 defining a corresponding contact node 118 when inflated. As best shown in FIGS. 1 and 6, the rows of first and second inflatable cells 112, 116 may extend in a side-to-side direction of the bladder 100. In other embodiments, the rows of first and second inflatable cells 112, 116 may extend in an end-to-end direction of the bladder 100, perpendicular to that shown. In further embodiments, the rows of first and second inflatable cells 112, 116 could extend in other directions.

In other embodiments, the bladder 100 could take any number of alternative forms.

A first bladder tube 120 defining a lumen therethrough extends from the first compartment 108 in fluid communication with the first variable air volume Z1. A second bladder tube 122 defining a lumen therethrough extends from the second compartment 110 in fluid communication with the second variable air volume Z2. The first and second bladder tubes 120, 122 are joined or otherwise connected to one or both of the first and second sheets 102, 104 in sealed engagement therewith. The ends of the first and second bladder tubes 120, 122 distant from the bladder 100 are configured for connection to a control system 300, for example, via an intervening connector 400, as will be discussed further below.

The envelope 200 includes a first (or upper) flexible panel 202 overlying a second (or lower) flexible panel 204. One or both of the first and second panels 202, 204 are flat and imperforate. In some embodiments, the first and second panels 202, 204 may be configured so that the first panel 202 stretches elastically to a greater degree than does the second panel 204 when the first panel 202 and the second panel 204 are subjected to the same or similar tensile load, as will be discussed further below. In an embodiment, the first panel 202 is substantially thinner than the second panel 204, for example, half the thickness of the second panel, so that the first panel 202 stretches elastically to a greater degree than does the second panel 204 when the first panel 202 and the second panel 204 are subjected to the same or similar tensile loads. The first and second panels 202, 204 are joined together by a peripheral seam 206, thereby defining an interior region 208 of the envelope and a third variable air volume Z3 separate from and independent of the first and second variable air volumes Z1, Z2. In other embodiments, the envelope 200 could take any number of alternative forms.

An envelope tube 210 defining a lumen therethrough extends from the interior region 208 of the envelope 200 in fluid communication with the third variable air volume Z3. The envelope tube 210 is joined or otherwise connected to either or both of the first and second panels 202, 204 in sealed engagement therewith. The envelope tube 210 includes an optional in-line envelope filter 212 configured to capture biohazardous material that may be present in the interior region 208 of the envelope 200 and mitigate a likelihood of such biohazardous material from contaminating the control system 300. The envelope tube 210 also includes an in-line calibrated envelope check valve 214 configured to preclude undesired entry of air to the interior region 208 of the envelope 200 through the envelope tube 210. As shown, the in-line calibrated envelope check valve 214 is outboard of the optional in-line envelope filter 212. In embodiments, the in-line calibrated envelope check valve 214 may be inboard of the optional in-line envelope filter 212.

As shown, both the in-line calibrated envelope check valve 214 and the optional in-line envelope filter 212 are outside the envelope 200. Also, the second bladder tube 122 is fluidly connected to the envelope tube 210 outside the envelope 200 and on the outboard side of the in-line envelope filter 212 and the in-line calibrated envelope check valve 214.

As mentioned above, FIGS. 1B, 2B, 3-5, and 6B show a variant 10′ of the support surface overlay 10 of, for example, FIG. 1A. The variant 10′ is identical the support surface overlay 10, except that both the in-line calibrated envelope check valve 214 and the optional in-line envelope filter 212 of the variant 10′ are within the envelope 200, the second bladder tube 122 is fluidly connected to the envelope tube 210 within the envelope 200, and the envelope tube 200, therefore, need not be joined or otherwise connected to either or both of the first and second panels 202, 204 in sealed engagement therewith.

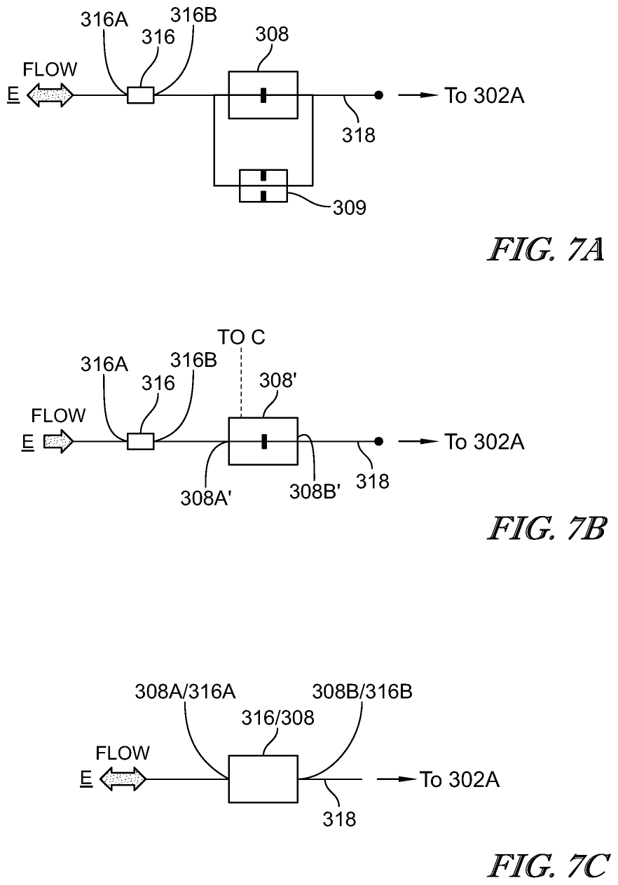

FIGS. 7-9 are schematic diagrams showing the control system 300 connected to the support surface overlay 10′ via the connector 400 and configured in various operating modes. The control system 300 may be connected to and configured for operation with the support surface overlay 10 in the same manner.

The control system 300 is operable to selectively and independently force pressurized air (or another working fluid) into, and relieve air (or another working fluid) from, the first and second variable air volumes Z1, Z2 defined by the first and second inflatable compartments 108, 110, respectively, to thereby selectively and independently inflate and deflate the corresponding inflatable cells 112, 116 through the first and second bladder tubes 120, 122. The control system 300 also is operable to selectively withdraw (or evacuate) air (or another working fluid) from the third variable air volume Z3 defined by the interior region of the envelope 200 to thereby selectively collapse the first and second panels 202, 204 of the envelope 200 against the first and second sheets 102, 104 of the bladder 100 within the envelope 200. The control system 300 further is operable to selectively withdraw air from the second variable air volume Z2 simultaneously with the withdrawal of air from the third variable air volume Z3.

In embodiments (not shown), a second envelope evacuation tube similar to the envelope evacuation tube 210 and including an in-line calibrated check valve similar to the in-line calibrated check valve 214 is connected to the first bladder tube 120 in a manner similar to that in which the second bladder tube 122 is connected to the envelope evacuation tube 210. In such embodiments, the control system 300 may further be operable to selectively withdraw air from the first variable air volume Z1 simultaneously with the withdrawal of air from the third variable air volume Z3.

The control system 300 includes a pneumatic pump 302, a first three-way control valve 304, and a second three-way control valve 306. In the embodiment shown, the control system 300 also includes an inlet flow controller 308, a pressure relief valve 310, a first pressure sensor 312, a second pressure sensor 314, an inlet filter 316, and a controller C. The control system 300 further includes fluid conduits 318 connecting the pneumatic pump 302, the first three-way control valve 304, the second three-way control valve 306, the inlet flow controller 308, the pressure relief valve 310, the first pressure sensor 312, the second pressure sensor 314, and the inlet filter 316 in fluid communication with each other, as will be discussed further below.

In some embodiments, any or all of the pressure relief valve 310, the first pressure sensor 312, the second pressure sensor 314, and the inlet filter 316 could be omitted.

The pneumatic pump 302 includes a pump inlet port 302A and a pump outlet port 302B. The pump inlet port 302A may be selectively fluidly coupled to a source of air or other fluid to be pressurized by the pump 302, as will be discussed further below. For example, the pump inlet port 302A may be selectively fluidly coupled to one or more of an environment E surrounding the control system 300, the first variable air volume Z1, and the second variable air volume Z2, as will be discussed further below. The pump outlet port 302B may be selectively fluidly coupled to the first variable air volume Z1 defined by the first inflatable compartment 108 and to the second variable air volume Z2 defined by the second inflatable compartment 110. The pump 302 also includes an electric motor electrically coupled to the controller C.

The first three-way control valve 304 includes a first port 304A fluidly coupled to the pump inlet port 302A, a second port 304B configured to be fluidly coupled to the first variable air volume Z1 defined by the first inflatable compartment 108, and a third port 304C fluidly coupled to the pump outlet port 302B. As shown, the first three-way flow control valve 304 may be embodied as a solenoid-operated valve having its solenoid electrically coupled to the controller C. In some such embodiments, including the illustrated embodiment, the first three-way flow control valve 304 may be configured so that: (a) the first port 304A is aligned with the second port 304B, and the third port 304 C is isolated from the first port 304A and the second port 304B, when the solenoid is de-energized; and (b) the second port 304B is aligned with the third port 304C, and the first port 304A is isolated from the second port 304B and the third port 304C, when the solenoid is energized.

The second three-way control valve 306 includes a first port 306A fluidly coupled to the pump inlet port 302A, a second port 306B configured to be fluidly coupled to the second variable air volume Z2 defined by the second inflatable compartment 110, and a third port 306C fluidly coupled to the pump outlet port 302B. As shown, the second three-way flow control valves 306 may be embodied as a solenoid-operated valve having its solenoid electrically coupled to the controller C. In some such embodiments, including the illustrated embodiment, the second three-way flow control valve 306 may be configured so that: (a) the first port 306A is aligned with the second port 306B, and the third port 306C is isolated from the first port 306A and the second port 306B, when the solenoid is de-energized; and (b) the second port 306B is aligned with the third port 306C, and the first port 306A is isolated from the second port 306B and the third port 306C, when the solenoid is energized.

The inlet flow controller 308 includes a first (or inlet port) 308A fluidly coupled to the environment E and a second (or outlet) port 308B fluidly coupled to the pump inlet port 302A. As shown in FIGS. 7, 8, and 9, the inlet flow controller 308 may be embodied as a calibrated inlet flow check valve. Accordingly, with reference to the illustrated embodiment, the inlet flow controller 308 may be referred to herein as the calibrated inlet flow check valve 308. The calibrated inlet flow check valve 308 is configured to allow flow from the first port 308A thereof to the second port 308B thereof, and to check flow from the second port 308B thereof to the first port 308A thereof. As such, the calibrated inlet flow check valve 308 is configured to allow flow from the environment to the pump inlet port 302A, and to check flow from within the control system 300 to the environment E. In such embodiments, the calibrated inlet flow check valve 308 is configured to open at a pressure differential selected so that the pump 302 may evacuate the envelope 200 prior to drawing air from the environment E, as will become better understood from the discussion below.

Embodiments including the calibrated inlet flow check valve 308 as described above lack means for automatically deflating inflated ones of the first and second inflatable compartments 108, 110, for example, when the control system 300 is powered off, as discussed further below. Instead, such embodiments may require disconnecting the control system 300 from the support surface overlay 10, for example, by breaking the connection at the connector 400, in order to deflate inflated ones of the first and or second inflatable compartments 108, 110. This may be undesirable in some applications.

Accordingly, in some embodiments including the calibrated inlet flow check valve 308, a flow restrictor 309, for example, an appropriately sized orifice, may be installed in parallel with the calibrated inlet flow check valve 308, for example, as shown in FIG. 7A. The flow restrictor 309 may allow controlled venting or deflation of inflated ones of the first and/or second compartments 108, 110 to the environment when the control system 300 is powered off or otherwise may be desired, as will be discussed further below. At the same time, the flow restrictor 309′ may provide sufficient inhibition to flow of intake air from the environment E during normal operation of the pump 302 to allow the control system 300 to evacuate the first and second compartments 108, 110 and the envelope 200 during normal operation of the control system 300, as will be discussed further below.

Alternatively, as shown in FIG. 7B, the inlet flow controller 308 may be embodied, for example, as a solenoid-operated inlet flow control valve 308′ having a first (or inlet) port 308A′ fluidly coupled to the environment E and a second (or outlet) port 308B′ fluidly coupled to the pump inlet port 302A, and having its solenoid electrically coupled to the controller C. In some such embodiments, the inlet flow control valve 308′ may be configured so that: (a) the inlet port 308A′ is aligned with the outlet port 308B′ when the solenoid is de-energized; and (b) the inlet port 308A′ is isolated from the outlet port 308B′ when the solenoid is energized. In such embodiments, the inlet flow control valve 308′ should be sized so as to provide sufficient inhibition to flow of intake air from the environment E during normal operation of the pump 302 to allow the control system 300 to evacuate the first and second compartments 108, 110 and the envelope 200 during normal operation of the control system 300, as will be discussed further below.

In some embodiments using the inlet flow control valve 308′, the inlet flow control valve 308′ could be configured so that: (a) the inlet port 308A′ is aligned with the outlet port 308B′ when the solenoid is energized; and (b) the inlet port 308A′ is isolated from the outlet port 308B′ when the solenoid is de-energized. Such embodiments may lack means for automatically deflating inflated ones of the first and second inflatable compartments 108, 110, for example, when the control system 300 is powered off, as discussed further below. In such embodiments, a flow restrictor, for example, an appropriately sized orifice, may be installed in parallel with the inlet flow control valve 308′ in a manner similar that described above and shown in in FIG. 7A in connection with the calibrated check valve 308 embodiment.

In some embodiments, the filter 316 could function as the inlet flow controller, for example, as shown in FIG. 7C, and as will be discussed further below. In such embodiments, the calibrated inlet flow check valve 308 and the inlet flow control valve 308′ could be omitted.

The pressure relief valve 310 has an inlet port 310A fluidly coupled to the pump outlet port 302B, and an outlet port 310B fluidly coupled to the environment E. The pressure relief valve 310 may be embodied as any form of pressure relief valve configured to be normally closed and to open when the pressure at the inlet port 310A exceeds the pressure at the outlet port 310B (which may be the ambient pressure of the environment E) by a first predetermined pressure value (or setpoint pressure).

The first pressure sensor 312 is fluidly coupled to the fluid conduit 318 between the second port 304B of the first three-way control valve 304 and the first variable air volume Z1, and electrically coupled to the controller C. The first pressure sensor 312 is configured to detect the pressure within the fluid conduit 318 between the second port 304B of the first three-way control valve 304 and the first variable air volume Z1, and to provide a signal indicative of the pressure within the fluid conduit 318 between the second port 304B of the first three-way control valve 304 and the first variable air volume Z1 to the controller C.

The second pressure sensor 314 is fluidly coupled to the fluid conduit 318 between the second port 306B of the second three-way control valve 306 and the second variable air volume Z2, and electrically coupled to the controller C. The second pressure sensor 314 is configured to detect the pressure within the fluid conduit 318 between the second port 306B of the second three-way control valve 306 and the second variable air volume Z2, and to provide a signal indicative of the pressure within the fluid conduit 318 between the second port 306B of the second three-way control valve 306 and the second variable air volume Z2 to the controller C.

The inlet filter 316 has an inlet port 316A fluidly coupled to the environment E and an outlet port 316B fluidly coupled to the inlet port of the inlet flow controller 308. The inlet filter 316 is configured to filter particulate matter from inlet air entering the control system 300 from the environment E.

As does any filter, the inlet filter 316 exhibits flow restriction characteristics that impart an impediment to air flow therethrough. In some embodiments, as suggested above, the flow restriction characteristics of the inlet filter 316 could be selected to be sufficiently great so as to enable the inlet filter 316 to function as the inlet flow controller 308. In such embodiments, the outlet port 316B of the inlet filter 316 would be fluidly coupled to the pump inlet port 302A.

The controller C is configured to receive control inputs from a user-operable control interface (not shown) and from the first and second pressure sensors 312, 314. The controller C also is configured to provide control outputs to the solenoids of the first and second three-way control valves 304, 306 and the inlet flow control valve 308. The controller C may be further configured to provide output signals to one or more of a display, indicator lamps or other visual indicators and speakers, chimes, or other audio indicators (not shown) that may provide a user with the status of operation of the control system 300. For example, the controller C may provide to the indicator lamps, audio elements, or display other status outputs reflecting whether the control system 300 is initializing, performing start-up testing, inflating a particular one of the first and second inflatable compartments 108, 110, deflating a particular one of the first and second inflatable compartments 108, 110, evacuating air from the envelope 200, and so on.

The controller C is configured to control the operation of the pump 302, the first and second three-way control valves 304, 306, and the inlet control valve 308 in response to user input to the control interface (not shown) and in response to pressure signals received from the first and second pressure sensors 312, 314, according to predetermined criteria and or logic that may be programmed into the controller C in hardware, software, or both, as will be discussed further below.

Various illustrative operational states of the support surface overlay 10 and control system 300 will now be discussed in detail.

### First Operational State—Stand-by, Powered Off

FIG. 7 shows schematically the support surface overlay 10 coupled to the pneumatic control system 300 in a first operational state according to the present disclosure. In the first operational state, the control unit 300 is in a stand-by, powered off state. As such, in the illustrated embodiment, the pump 302, the solenoids of the first and second three-way control valves 304, 306 and the inlet flow control valve 308 are de-energized, as are the first and second pressure sensors 312, 314. In this state, the support surface overlay 10 may be generally deflated or in the process of deflating, by venting air to the environment through the inlet flow controller 308.

More specifically, in the first operational state: (a) the first port 304A of the first three-way control valve 304 is aligned with the second port 304B of the first three-way control valve 304, and the third port 304C of the first three-way control valve 304 is isolated from the first port 304A and the second port 304B of the first three-way control valve 304; (b) the first port 306A of the second three-way control valve 306 is aligned with the second port 306B of the second three-way control valve 306, and the third port 306C of the second three-way control valve 306 is isolated from the first port 306A and the second port 306B of the second three-way control valve 306; and (c) the inlet port 308A of the inlet flow control valve 308 is aligned with the outlet port 308B of the inlet flow control valve.

As such, the pump inlet port 302A is aligned with the first and second variable air volumes Z1, Z2 via the first and second three-way control valves 304, 306, with the environment E via the inlet flow control valve 308, and with the third variable air volume Z3 via the check valve 214 of the support surface overlay system 10. The first and second variable air volumes Z1, Z2 are aligned with each other via the first and second three-way control valves 304, 306. The pump outlet 302B is isolated from the first and second variable air volumes Z1, Z2 by the first and second three-way control valves 304, 306. Also, the first, second, and third air variable volumes Z1, Z2, Z3 may be at ambient pressure (that is, the pressure of the environment E) and in a mostly empty or deflated state.

The pressure in the fluid conduit 318 coupling the pump outlet port 302B with the third ports 304C, 306C of the first and second three-way control valves 304, 306 and the inlet port 310A of the pressure relief valve 310 may be at or near ambient pressure and, in any event, is lower than the pressure relief valve 310 setpoint pressure. As such, the pressure relief valve 310 is closed.

### Second Operational State—Inflation of First Inflatable Compartment and Deflation/Evacuation of Second Inflatable Compartment and Envelope

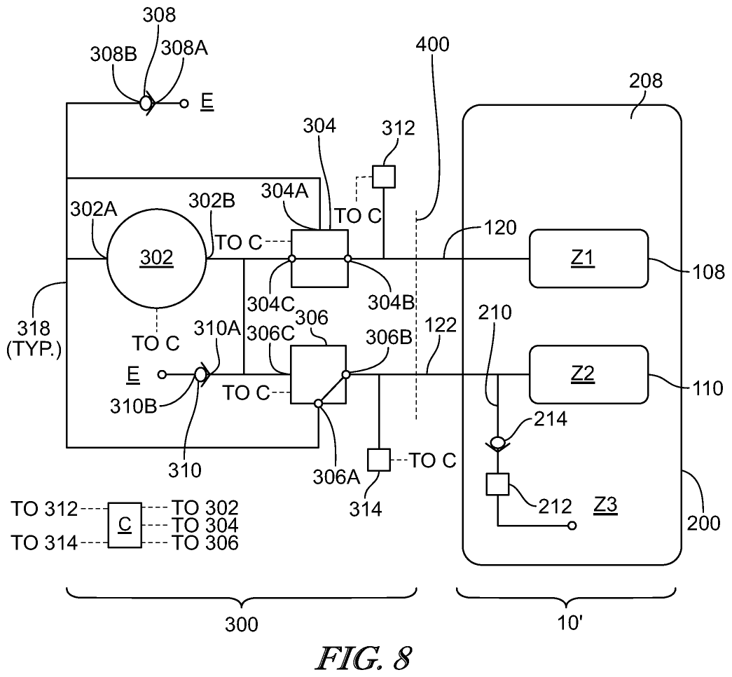

FIG. 8 shows schematically the support surface overlay 10 coupled to the pneumatic control system 300 in a second operational state according to the present disclosure. In the second operational state, the control unit 300 is configured to run the pump 302 and to align the first and second three-way control valves 304, 306 and the inlet flow control valve 308 so that the pump 302 may withdraw air from the second and third variable air volumes Z2, Z3, to pressurize the air withdrawn from the second and third variable air volumes Z2, Z3, and to discharge the pressurized air to the first variable air volume Z1.

More specifically, in the second operational state: (a) the second port 304B of the first three-way control valve 304 is aligned with the third port 304C of the first three-way control valve 304, and the first port 304A of the first three-way control valve 304 is isolated from the second port 304B and the third port 304C of the first three-way control valve 304; (b) the first port 306A of the second three-way control valve 306 is aligned with the second port 306B of the second three-way control valve 306, and the third port 306C of the second three-way control valve 306 is isolated from the first port 306A and the second port 306B of the second three-way control valve 306; and (c) the inlet port 308A of the inlet flow control valve 308 is isolated from the outlet port 308B of the inlet flow control valve.

As such, the pump inlet port 302A is aligned with the second and third variable air volumes Z2, Z3 via the second three-way control valve 306. The pump inlet port 302A is isolated from the environment E by the inlet flow control valve 308, and from the first variable air volume Z1 by the first three-way control valve 304. The pump outlet port 302B is aligned with the first variable air volume Z1 via the first three-way control valve 304, and isolated from the second variable air volume Z2 by the second three-way control valve 306.

The pump 302 is running and thereby withdraws air, if any, from the second and third variable air volumes Z2, Z3, thereby evacuating the second and third variable air volumes Z2, Z3, and collapsing the first and second sheets 202, 204 of the envelope 200 against the first and second sheets 102, 104 of the bladder 100. The envelope check valve 214 may selectively open as may be necessary to allow air to be withdrawn from the third variable air volume Z3. Otherwise, the check valve 214 is closed. The pump 302 pressurizes the intake air and discharges it through the pump outlet port 302B to the first variable air volume Z1 via the first three-way control valve 304, thereby continuing to inflate and pressurize the first inflatable compartment 108.

The first pressure sensor 312 detects pressure in the fluid conduit 318 coupling the first three-way control valve 304 with the first variable air volume Z1. The second pressure sensor 314 detects pressure in the fluid conduit 318 coupling the second three-way control valve 306 with the second variable air volume Z2.

The pump 302 continues to run until the first pressure sensor 312 detects pressure corresponding to the desired inflation pressure for the first variable air volume Z1 and the second pressure sensor 314 detects pressure corresponding to the desired vacuum for the second and third variable air volumes Z2, Z3.

In the event the second pressure sensor detects pressure corresponding to the desired vacuum for the second and third variable air volumes Z2, Z3 before the first pressure sensor detects pressure corresponding to the desired inflation pressure for the first variable air volume Z1, the control system 300 may cause the inlet flow control valve 308 to open to allow make up air into the system from the environment.

With the inlet flow control valve 308 so opened, should the second pressure sensor continue to detect pressure corresponding to the desired vacuum for the second and third variable air volumes Z2, Z3 and the first pressure sensor continue to detect pressure less than the desired inflation pressure for the first variable air volume Z1 for predetermined time or longer, which condition might be indicative of a system failure, the control system 300 may issue an alarm or revert the system to the first operational state or take other action.

If the first pressure sensor 312 detects pressure corresponding to the desired inflation pressure for the first variable air volume Z1 before the second pressure sensor detects pressure corresponding to the desired vacuum for the second and third variable air volumes Z2, Z3, the pump 302 continues to run, and the pressure relief valve opens to relieve air to the environment to thereby maintain pressure at the pressure relief valve below the pressure relief valve setpoint.

### Third Operational State—Maintain Inflation of First Inflatable Compartment

In the third operational state, the control system 300 aligns the first and second three-way control valves 304, 306 in the same alignment as in the second operational state, aligns the inlet flow control valve 308 in the closed position, and turns the pump 302 off.

The first pressure sensor 312 continues to detect pressure in the fluid conduit 318 coupling the first three-way control valve 304 with the first variable air volume Z1, and the second pressure sensor 314 continues to detect pressure in the fluid conduit 318 coupling the second three-way control valve 306 with the second variable air volume Z2. If the first pressure sensor 312 detects pressure below the setpoint, or the second pressure sensor 314 detects pressure above the setpoint, the control system may cycle the pump 302 on and off as necessary to revert the pressure detected by the first pressure sensor 312 to or above its setpoint and the pressure detected by the second pressure sensor 314 to or below its setpoint.

### Fourth Operational State—Inflation of Second Inflatable Compartment and Deflation of First Inflatable Compartment.

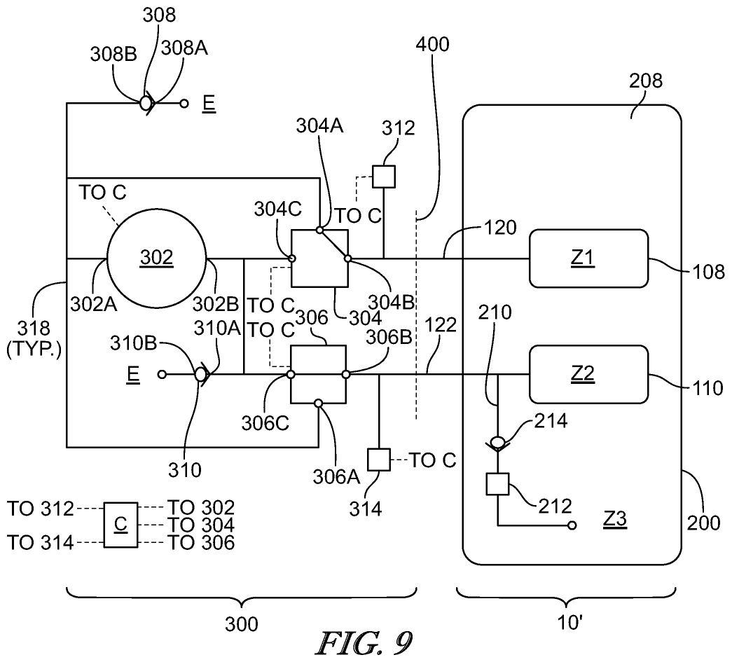

FIG. 9 shows schematically the support surface overlay 10 coupled to the pneumatic control system 300 in a fourth operational state according to the present disclosure. In the fourth operational state, the control unit 300 is configured to run the pump 302 and to align the first and second three-way control valves 304, 306 and the inlet flow control valve 308 so that the pump 302 may withdraw air from the first variable air volume Z1, to pressurize the air withdrawn from the first variable air volume Z1, and to discharge the pressurized air to the second variable air volume Z2.

More specifically, in the second operational state: (a) the first port 304A of the first three-way control valve 304 is aligned with the second port 304B of the first three-way control valve 304, and the third port 304C of the first three-way control valve 304 is isolated from the first port 304A and the second port 304B of the first three-way control valve 304; (b) the second port 306B of the second three-way control valve 306 is aligned with the third port 306C of the second three-way control valve 306, and the first port 306A of the second three-way control valve 306 is isolated from the second port 306B and the third port 306C of the second three-way control valve 306; and (c) the inlet port 308A of the inlet flow control valve 308 is isolated from the outlet port 308B of the inlet flow control valve.

As such, the pump inlet port 302A is aligned with the first variable air volume Z1 via the first three-way control valve 304. The pump inlet port 302A is isolated from the environment E by the inlet flow control valve 308, and from the second and third variable air volumes Z2, Z3 by the second three-way control valve 306. The pump outlet port 302B is aligned with the second variable air volume Z2 via the second three-way control valve 306, and isolated from the first variable air volume Z1 by the first three-way control valve 304.

The pump 302 is running and thereby withdraws air, if any, from the first variable air volume Z1, thereby evacuating the first variable air volume Z1, and collapsing the first and second sheets 202, 204 of the envelope 200 against the first and second sheets 102, 104 of the bladder 100. The pump 302 pressurizes the intake air and discharges it through the pump outlet port 302B to the second variable air volume Z2 via the second three-way control valve 306, thereby inflating and pressurizing the second inflatable compartment 110.

The first pressure sensor 312 detects pressure in the fluid conduit 318 coupling the first three-way control valve 304 with the first variable air volume Z1. The second pressure sensor 314 detects pressure in the fluid conduit 318 coupling the second three-way control valve 306 with the second variable air volume Z2.

The pump 302 continues to run until the second pressure sensor 314 detects pressure corresponding to the desired inflation pressure for the second variable air volume Z2 and the first pressure sensor 312 detects pressure corresponding to the desired vacuum for the first variable air volume Z1.

In the event the first pressure sensor detects pressure corresponding to the desired vacuum for the first variable air volume Z1 before the second pressure sensor detects pressure corresponding to the desired inflation pressure for the second variable air volume Z2, the control system 300 may cause the inlet flow control valve 308 to open to allow make up air into the system from the environment.

With the inlet flow control valve 308 so opened, should the first pressure sensor continue to detect pressure corresponding to the desired vacuum for the first variable air volume Z1 and the second pressure sensor continue to detect pressure less than the desired inflation pressure for the second variable air volume Z2 for a predetermined time or longer, which condition might be indicative of a system failure, the control system 300 may issue an alarm or revert the system to the first operational state or take other action.

If the second pressure sensor 314 detects pressure corresponding to the desired inflation pressure for the second variable air volume Z2 before the first pressure sensor detects pressure corresponding to the desired vacuum for the first variable air volume Z1, the pump 302 continues to run, and the pressure relief valve opens to relieve air to the environment to thereby maintain pressure at the pressure relief valve below the pressure relief valve setpoint.

### Fifth Operational State—Maintain Inflation of Second Inflatable Compartment

In the fifth operational state, the control system 300 aligns the first and second three-way control valves 304, 306 in the same alignment as in the fourth operational state, aligns the inlet flow control valve 308 in the closed position, and turns the pump 302 off.

The second pressure sensor 314 continues to detect pressure in the fluid conduit 318 coupling the second three-way control valve 306 with the second variable air volume Z2, and the first pressure sensor 312 continues to detect pressure in the fluid conduit 318 coupling the first three-way control valve 304 with the first variable air volume Z1. If the second pressure sensor 314 detects pressure below the setpoint, or the first pressure sensor 312 detects pressure above the setpoint, the control system may cycle the pump 302 on and off as necessary to revert the pressure detected by the second pressure sensor 314 to or above its setpoint and the pressure detected by the first pressure sensor 312 to or below its setpoint.

### Subsequent Operational States

Following the fifth operational state, the control system may repeat the second through fifth operational states indefinitely.

The embodiments shown and described herein are illustrative and may be modified as would be understood by one skilled in the art without departing from the scope of the appended claims.

We claim:

1. A support surface overlay system comprising:
a therapeutic support surface overlay comprising:
a first inflatable compartment defining a first variable working fluid volume;
a second inflatable compartment defining a second variable working fluid volume separate from and independent of the first variable working fluid volume; and
an envelope enclosing the first and second inflatable compartments, the envelope defining a third variable working fluid volume separate from and independent of the first variable working fluid volume and the second variable working fluid volume; and
a control system configured to selectively and alternatingly inflate and deflate the first and second inflatable compartments and to concurrently evacuate a working fluid from an uninflated one of the first variable working fluid volume and the second variable working fluid volume and from the third variable working fluid volume, the control system comprising:
a pneumatic pump having a pump inlet port and a pump outlet port;
a first three-way control valve having a first port fluidly coupled to the pump inlet port, a second port fluidly coupled to the first variable working fluid volume, and a third port coupled to the pump outlet port; and
a second three-way control valve having a first port fluidly coupled to the pump inlet port, a second port fluidly coupled to the second variable working fluid volume and to the third variable working fluid volume, and a third port coupled to the pump outlet port.

2. The support surface overlay system of claim 1 wherein, in a first operational state:
the first three-way control valve is configured to enable fluid communication between the first variable working fluid volume and the pump inlet port and to disable fluid communication between the first variable working fluid volume and the pump outlet port;
the second three-way control valve is configured to enable fluid communication between the second variable working fluid volume, the third variable working fluid volume, and the pump inlet port, and to disable fluid communication between the second variable fluid volume and the pump outlet port; and
the pump is configured in a non-pumping state.

3. The support surface overlay system of claim 2 wherein, in a second operational state:
the first three-way control valve is configured to disable fluid communication between the first variable working fluid volume and the pump inlet port and to enable fluid communication between the first variable working fluid volume and the pump outlet port;
the second three-way control valve is configured to enable fluid communication between the second variable working fluid volume, the third variable working fluid volume, and the pump inlet port and to disable fluid communication between the second variable working fluid volume and the pump outlet port; and
the pump is configured in a pumping state.

4. The support surface overlay system of claim 3 wherein, in a third operational state:
the first three-way control valve is configured to disable fluid communication between the first variable working fluid volume and the pump inlet port and to enable fluid communication between the first variable working fluid volume and the pump outlet port;
the second three-way control valve is configured to enable fluid communication between the second variable working fluid volume, the third variable working fluid volume, and the pump inlet port and to disable fluid communication between the second variable working fluid volume and the pump outlet port; and
the pump is configured in a non-pumping state.

5. The support surface overlay system of claim 4 wherein, in a fourth operational state:
the first three-way control valve is configured to enable fluid communication between the first variable working fluid volume and the pump inlet port and to disable fluid communication between the first variable working fluid volume and the pump outlet port; and
the second three-way control valve is configured to disable fluid communication between the second variable working fluid volume, the third variable working fluid volume and the pump inlet port and to enable fluid communication between the second working variable fluid volume and the pump outlet port; and
the pump is configured in a pumping state.

6. The support surface overlay system of claim 5 wherein, in a fifth operational state:
the first three-way control valve is configured to enable fluid communication between the first variable working fluid volume and the pump inlet port and to disable fluid communication between the first variable working fluid volume and the pump outlet port; and
the second three-way control valve is configured to disable fluid communication between the second variable working fluid volume, the third variable working fluid volume and the pump inlet port and to enable fluid communication between the second working variable fluid volume and the pump outlet port; and
the pump is configured in a non-pumping state.

7. The support surface overlay system of claim 1 further comprising a check valve configured to allow flow out of the third variable working fluid volume and to check flow into the third variable working fluid volume.

8. The support surface overlay system of claim 1 further comprising an inlet flow control device having a first port fluidly coupled to an environment external to the control system and a second port fluidly coupled to the pump inlet port.

9. The support surface overlay system of claim 8 wherein the inlet flow control device is a calibrated check valve.

10. The support surface overlay system of claim 9 wherein the calibrated check valve is set to open at a predetermined pressure corresponding to a predetermined vacuum in the second and third variable working fluid volumes.

11. The support surface overlay system of claim 1 further comprising:
an envelope check valve having a first port fluidly coupled to the third variable air volume and a second port fluidly coupled to the second port of the second three-way control valve and to the second variable air volume, the envelope check valve configured to enable fluid flow out of the third variable air volume and to check fluid flow into the third variable air volume.

12. The support surface overlay of claim 1 further comprising a pressure relief valve having a first port fluidly coupled to the pump outlet port and a second port fluidly coupled to an environment external to the control system.

13. The support surface overlay of claim 12 wherein the pressure relief valve is a calibrated check valve.

14. The support surface overlay of claim 12 wherein the wherein the calibrated check valve is set to open at a predetermined pressure corresponding to a predetermined pressure in an inflated one of the first and second variable working fluid volumes.

15. The support surface overlay system of claim 1 further comprising:
a controller;
a first pressure sensor in fluid communication the first variable working fluid volume; and
a second pressure sensor in fluid communication with the second and third variable working fluid volumes,
wherein the controller is configured to control the operation of the pump in response to at least one signal from at least one of the first and second pressure sensors.
